(19) United States
(12) Patent Application Publication
(10) Pub. No.: US 2015/0375223 A1
(43) Pub. Date: Dec. 31, 2015

(54) Disposable Tip for pricking septum of a sample vial for sample preparation and/or analysis.

(71) Applicants: Ashok Kumar Shukla, Ellicott City, MD (US); Mukta Misra Shukla, Ellicott City, MD (US)

(72) Inventors: Ashok Kumar Shukla, Ellicott City, MD (US); Mukta Misra Shukla, Ellicott City, MD (US)

(21) Appl. No.: 14/746,684

(22) Filed: Jun. 22, 2015

Related U.S. Application Data
(60) Provisional application No. 61/998,179, filed on Jun. 20, 2014.

(51) Int. Cl. B01L 3/02; G01N 1/34

(52) U.S. Cl. CPC B01L 3/0275; G01N 1/34; B01L 2300/0672; B01L 2300/0838; B01L 2300/0681

(57) ABSTRACT

This invention relates to a disposable pipette tip or tube designed to perform biological or chemical sample preparation, purification or separation where the samples are in a closed bottle with a lid with septum or membrane. In an automatic sampler for HPLC or Gas chromatography, septum closed vials are used to prevent samples from drying out or evaporating during the analytical process. The auto sampler needles are used to prick the septum at the vial to get the sample out for injecting in injector for the analysis. The same needle takes the samples from each vial, and therefore a contamination of the samples is possible.

Priority date provisional Application Filed on Jun. 20, 2014. Application No. 62/176,026

### FIELD OF THE INVENTION

This invention relates to a disposable pipette tip or tube designed to perform biological or chemical sample preparation, purification or separation where the samples are in a closed bottle with a lid with septum or membrane. In an automatic sampler for HPLC or Gas chromatography, septum closed vials are used to prevent samples from drying out or evaporating during the analytical process. The auto sampler needles are used to prick the septum at the vial to get the sample out for injecting in injector for the analysis. The same needle takes the samples from each vial, and therefore a contamination of the samples is possible.

Furthermore, cleaning the needle between each sample is also a time consuming process.

### BACKGROUND OF INVENTION

In biological or chemical analysis, glass syringes are used to prick the septum to get the sample out of vials or containers. In this process, the same needle is used again and again, which sometimes contaminates the samples. Similarly, in automatic liquid handling systems, same needle is used again and again to transfer the sample or in sample cleanup process. In some cases disposable needles are used which are used in medical applications. However, These commercially available needles are placed in a luer-lock plastic fittings via a glue. This glue sometimes dissolves in organic solvents which in turn may contaminate the sample and interfere with the analysis such as Mass spectrometry.

Tube (1): means capillary, tube, pipette tip, with any geometry of hole such as round, square, cylindrical, triangular, elliptical, parabolic or any shape which can be in the form of a tube. Internal diameter of the tube is from 0.001- 25 mm. The length of the tube can be from 0.1-10000 mm. The tube 1 is made of glass, plastic, metal, polymer.

Capillary (Needle) (2) with any geometry of hole such as round, square, cylindrical, triangular, elliptical, parabolic or any shape which can be in the form of a tube. Internal diameter of the tube is from 0.001-25 mm. The length of the tube can be from 0.1-10000 mm. Capillary (2) is made of glass, plastic, metal, polymer or any hard material to strengthen the tube.

Chromatographic material means, the regular, irregular, spherical, broken particles of silica, metal, polymers, metal oxides, non-metal oxides. These particles can be porous or nonporous. The pore size can be from 20-40000 nm. These particles can be modified chemically, physically, mechanically or by affinity media. The size of the particles can be from 0.001-1 mm.

Here we describe a disposable pipette tip or a hollow tube containing a narrow bore capillary or tube. Said capillary is fixed at one narrow end of pipette tip. This capillary in the pipette tip is fixed without glue. These disposable tips eliminate the cross contamination of samples from one vial to the other vial, because each time a new needle tip is used. Further this needle containing pipette tip does not contain any glue therefore, no contamination occur during the sample prep. or transport of the sample from one container to the other. Further, these needle tips can be used as the disposable HPLC (High Performance Liquid Chromatography) sample Injection tips. Up to now, there are no disposable HPLC syringes available. In most cases, a glass syringe is used to inject the sample and the syringe is cleaned up for next sample. These glass syringes are costly; therefore they cannot be used as disposable HPLC syringe. The disposable needle Tips described here can overcome the contamination problem. In some cases such as enzyme reaction and radioactive chemical analysis, cross contamination of sample is very critical. The invention described here can overcome such problems easily.

Furthermore, these needles contain chromatographic media, for the sample prep., concentration, cleanup of biological and chemical samples before further analysis. This is helpful for the faster sample analysis.

The various features of novelty, which characterize the invention, are pointed out with particularity in the claims annexed to and forming a part of this disclosure. For a better understanding of the invention, its advantages and objects, reference is made to the accompanying drawings and descriptive matter in which a preferred embodiment of the invention is illustrated.

### BRIEF DESCRIPTION OF THE DRAWINGS

The foregoing and still other objects of this invention will become apparent, along with various advantages and features of novelty residing in the present embodiments, from study of the following drawings, in which:

FIG. 1 is an expanded view of one embodiment of the needle pipette tip containing needle, according to the present invention.

FIG. 2 is an expanded view of one embodiment of the needle pipette tip, according to the present invention, containing a chromatography material in the needle

FIG. 3 is an expanded view of one embodiment of the needle pipette tip, according to the present invention, containing a chromatography material in the tip above the needle.

FIG. 4 is an expanded view of one embodiment of the needle pipette tip, according to the present invention, where the needle is fixed by twisting the pipette tip around the needle.

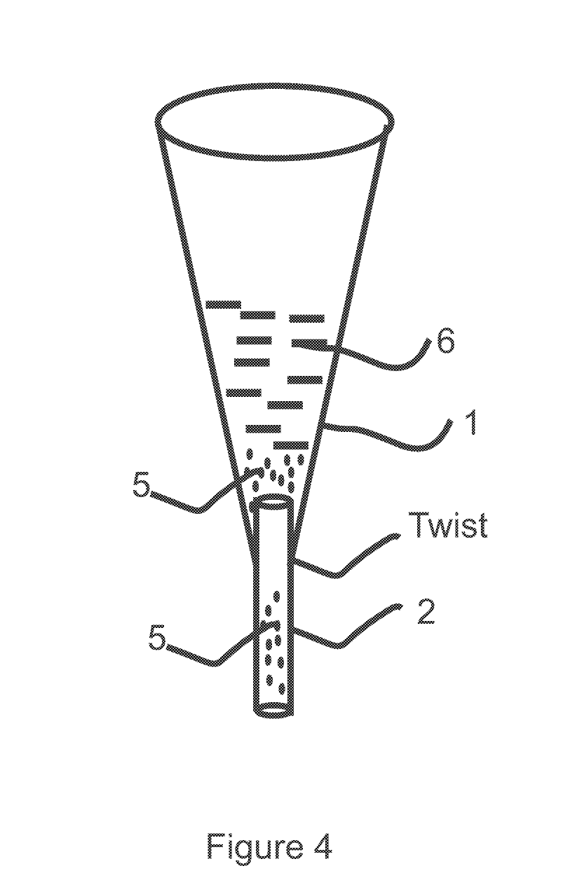

FIG. 5 is an expanded view of one embodiment of the needle pipette tip, according to the present invention, pricking through septum of a container or vial.

### DESCRIPTION OF THE PREFERRED EMBODIMENTS

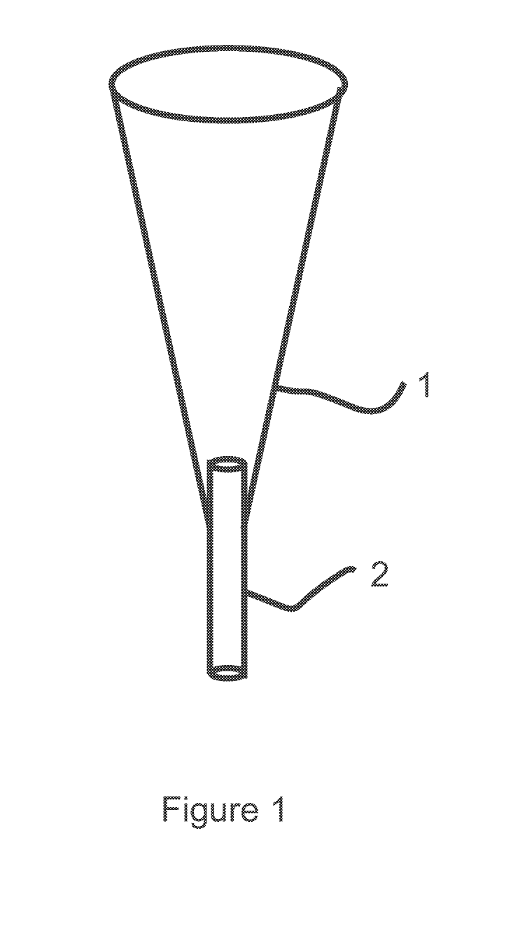

Referring to the drawings, FIG. 1 is an expanded view of one embodiment of the pipette tip or a tube (1), and needle (2). The needle is fixed in one end of the tube (1) and other end of said tube is open to connect to the pipettor or any liquid handling system.

According to the present invention, the internal diameter of the tube (1)can be from 0.001-25 mm. The needle (2) outer diameter can be from 0.0001-25 mm. The needle (capillary) (2) is hollow in side. The diameter of the needle (2) is smaller than the diameter of the tube (1). The inner diameter of said needle is between 0.000001-24.9 mm. The Tube (1) may be square, cylindrical, triangular, elliptical, parabolic or of any shape.

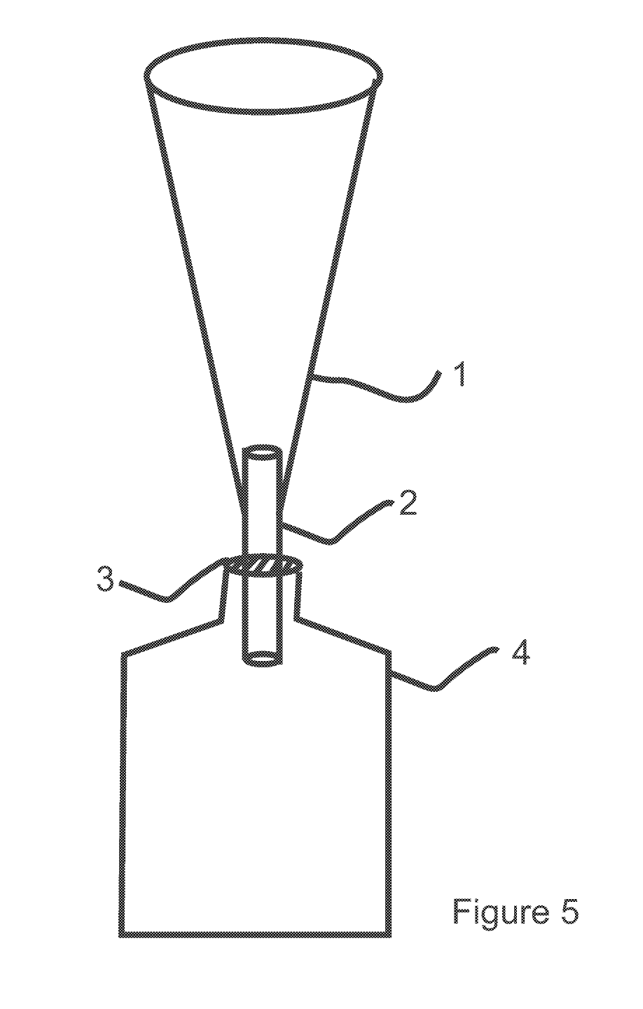

As in FIG. 5, needle gives strength to the pipette tip so that it can prick the septum (3) of the sample container or vial or bottle (4).

The tube (1) can be straight, tapered or of any other geometry. The tube (1) may be of any length between 1-10,000 mm. Said pipette tip (1) can be made of one or more materials including but not limited to polytetrafluoroethylene, polysulfone, polyethersulfone, cellulose acetate, polystyrene, polystyrene/acrylonitrile copolymer, PVDF, metal and glass polypropylene, polyethylene or any polymer which can be molded. Said pipette tip (tube) (1) can have a volume anywhere from 0.0001 to 100 milliliters.

The needle (2) can be straight, tapered or of any other geometry. Said needle (2) can be made of one or more materials including but not limited to polytetrafluoroethylene, polysulfone, polyethersulfone, cellulose acetate, polystyrene, polystyrene/acrylonitrile copolymer, PVDF, metal and glass polypropylene, polyethylene or any polymer which can be molded. Said needle or capillary (2) can have a volume anywhere from 0.00001 to 100 milliliters. The length of the needle (2) may be from 1-10,000 mm. The needle (2) may be square, cylindrical, triangular, elliptical, parabolic or of any shape.

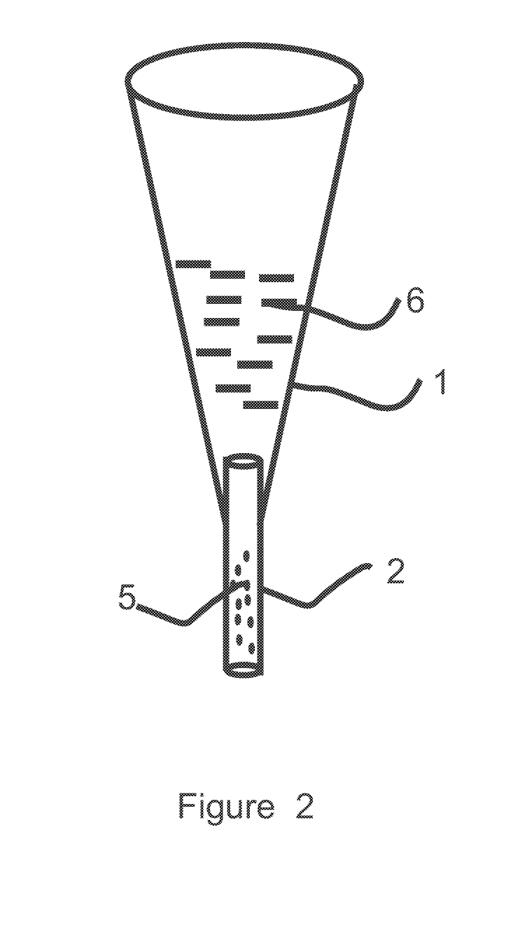

FIG. 2 is an expanded view of one embodiment of the needle pipette tip (1), according to the present invention, containing a chromatography material (5) within the needle. FIG. 2 also shows a sample (6) being placed on top of the needle (2). Said chromatography material (5) can consist of one or more different types of chromatography or separation materials including, but not limited to, chromatographic silica, affinity, IMAC, Metal oxides, polystyrene, carbon, polymers, media, gels, bacteria, living cells, solid powders or any other media used for the purposes of sample filtration, separation or purification. The chromatographic material (5) can also be composed of non-silica, polymer-based, active charcoal, zirconium, titanium, metal oxide, non-metal oxide or other materials. The chromatographic material may be porous nonporous. Chromatographic material means, the regular, irregular, spherical, broken particles of silica, metal, polymers, metal oxides, non-metal oxides.

These particles can be porous or nonporous. The pore size can be from 20-40000 nm. These particles can be modified chemically, physically, mechanically or by affinity media. The size of the particles can be from 0.001-1 mm.

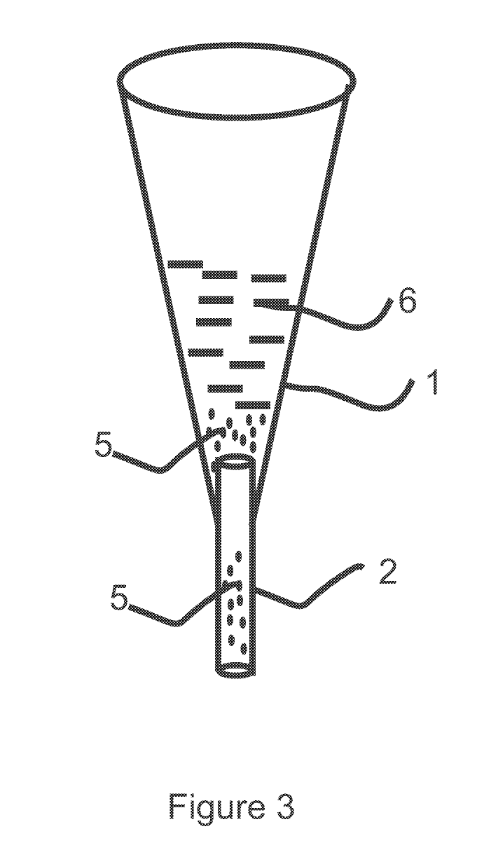

In FIG. 3 chromatographic material is present in a tube (1) in loose form or packed or embedded.

The capillary (2) has open ends at both sides. The capillary (2) is fixed in tube (1) at the position where, it is touching (6) the tube(1). The capillary may or may not be in the entire length of the Tube (1) or it may be partially outside of tube (1). The volume of the capillary (2) may decide the sample volume. But one end of the capillary will be inside the tube (1).

The capillary (2) can be fixed in the pipette Tip (1)
1. By twisting the pipette tip (1) along the capillary (2).
2. By fusing capillary (2) into the pipette tip (1).
3. Using the glue to fix the capillary in the Tip (1).
4. Using heat, physical force,
5. or by a process selected from the group consisting of but not limited to a chemical , physical, mechanical, thermal, pressure, during molding, during extruding of the said tube; and, combination thereof.

Said tube (1) can be arranged in multiple units of the pipette tip or tube (1), joined together in a 96-tube format. Multiple units of said pipette tips (1) can be joined together to develop a system for the simultaneous preparation of multiple samples. Said pipette tips (1) can be joined together in any type of configuration including but not limited to 2-unit, 8-unit, 48-unit, 96-unit, 384-unit or 1536-unit formats. The pipette tip (1) is either a single unit or a multi-unit system and can be combined with a piston or similar device designed to pull the sample into the tip or push the sample out of the tip.

The pipette tip (tube) (1) described in the present invention has many small sample preparation, filtration and purification applications including but not limited to the purification of DNA, proteins, peptides, lipids, carbohydrates, vitamins and other chemicals and bio-molecules. Separation of sample components can be based on size, chemical properties or physical properties of the sample's component molecules and particles. Samples purified by these methods can be used for further analysis, through mass spectrometry, High Performance Liquid Chromatography (HPLC), electrophoresis, capillary electrophoresis, NMR, enzyme assays, protein binding assays and other chemical or biochemical reactions.

The chromatographic material (5) in needle (2) is placed by a process selected from the group consisting of but not limited to a chemical , physical, mechanical, thermal, embedded, monolithic formation, pressure, heat, during molding, during extruding of the said needle (2); and, combination thereof.

The chromatographic material (5) in tube (1) is placed by a process selected from the group consisting of but not limited to a chemical , physical, mechanical, thermal, embedded, monolithic formation, pressure, heat, during molding, during extruding of the said tube (1); and, combination thereof. The Chromatographic material (5) in tube (1) placed above the needle end (2) or may have a gap between needle end and chromatographic media.

The broader usefulness of the invention may be illustrated by the following examples.

### EXAMPLE #1

### HPLC Pipette Tip Injector:

A commercially available polypropylene micro pipette tip 10-200 ul, fixed with a 3 cm long and 22 Gauge needle. The needle is fixed in the pipette tip, by twisting the pipette tip around the outer surface of the needle. This device is used to inject the sample in HPLC manual injector followed by an analysis by the HPLC photometer to check for reproducibility.

### EXAMPLE #2

### Sample Prep in HPLC Needle:

A commercially available polypropylene micro pipette tip 10-200 ul, fixed with a 3 cm long and 22 Gauge needle. The needle is fixed in pipette tip, by twisting the pipette tip around the outer surface of the needle. In the inner side of the needle, Chromatographic material C18 was embedded with the help of a low melting polymer. This device is used for desalting of a peptide solution based on solid phase extraction method. The desalted Peptides are injected in HPLC manual injector and analyzed by the HPLC photometer for the purity of the peptides.

While a specific embodiment of the invention has been shown and described in detail to illustrate the application of the principles of the invention, it is understood that the invention may be embodied otherwise without departing from such principles and that various modifications, alternate constructions, and equivalents will occur to those skilled in the area given the benefit of this disclosure and the embodiment described herein, as defined by the appended claims.

1. A device for biological chemical sample preparation consists of a tube (pipette Tip) that has two open ends and the said tube contains a capillary inserted into the said tube to strengthen the lower end of the said tube to be able to prick the septum of sample preparation vial for sample transport for analysis, preparation and/or mixing.

2. A device as in claim 1, wherein said tube is selected from the group consisting of but not limited to tube, capillary, pipette tip, housing, any shape, any size, column, and tapered column; and, combination thereof.

3. A device as in claim 1, wherein said capillary is selected from the group consisting of but not limited to tube, capillary, any shape, any size, housing, column, and tapered column; and, combination thereof.

4. A device as in claim 1, wherein multiple units of said tube are joined together in any type of configuration including but not limited to 2-unit, 8-unit, 48-unit, 96-unit, 384-unit or 1536-unit formats.

5. A device as in claim 1, wherein said tube is made of one or more materials selected from the group consisting of but not limited to polymer, polypropylene, polyethylene polytetrafluoroethylene, polysulfone, polyethersulfone, cellulose acetate, polystyrene, polystyrene/acrylonitrile copolymer, PVDF, and glass, metal; and, combination thereof.

6. A device as in claim 1, wherein said capillary is made of one or more materials selected from the group consisting of but not limited to polymer, polypropylene, polyethylene polytetrafluoroethylene, polysulfone, polyethersulfone, cellulose acetate, polystyrene, polystyrene/acrylonitrile copolymer, PVDF, and glass, metal; and, combination thereof.

7. A device as in claim 1, wherein the said tube is of a volume between 0.0001 and 100 milliliters, and the length of said tube is between 0.1-1000 mm, and internal diameter of the said tube is between 0.0001-25 mm.

8. A device as in claim 1, wherein the said capillary is of a volume between 0.00001 and 100 milliliters, and the length of said tube is between 0.1-1000 mm, and internal diameter of the said tube is between 0.00001-25 mm.

9. A device as in claim 1, wherein the said tube contains chromatographic particles for sample preparation selected from the group consisting of but not limited to powder, separation material, porous, nonporous-chromatographic media, silica, polystyrene, carbon, graphite, polymers, media, gels, bacteria, living cells, solid powders, metal oxides, titanium dioxide, zirconium dioxide, non-metal oxides;
or any other media used for the purposes of sample filtration, separation or purification; said particles can be chemically or physically modified to enhance the quality of separation; and/or combination thereof.

10. A device as in claim 1, wherein the said capillary contains chromatographic particles for sample preparation selected from the group consisting of but not limited to powder, separation material, porous, nonporous-chromatographic media, silica, polystyrene, carbon, graphite, polymers, media, gels, bacteria, living cells, solid powders, metal oxides, titanium dioxide, zirconium dioxide, non-metal oxides;
or any other media used for the purposes of sample filtration, separation or purification; said particles can be chemically or physically modified to enhance the quality of separation; and/or combination thereof.

11. A device as in claim 1 is used for sample preparation process selected from the group consisting of but not limited to separation , filtration , purification and concentration of the said molecules, through centrifugation, gravitation, vacuum suction, pressure application, or any other applicable methods; and, combination thereof.

12. A sample preparation process as in claim 8, wherein said sample preparation process is performed for applications from the group selected from consisting but not limited to purification of proteins, peptides, DNA and other bio-molecules, size-based separation of molecules, chemical properties based separation of sample components, physical properties based separation of sample components; and, combination thereof.
